(19) United States
(12) Patent Application Publication
(10) Pub. No.: US 2013/0311614 A1
(43) Pub. Date: Nov. 21, 2013

(54) METHOD FOR RETRIEVING CONTENT AND WIRELESS COMMUNICATION DEVICE FOR PERFORMING SAME

(71) Applicant: Apostolis K. Salkintzis, Athens (GR)

(72) Inventor: Apostolis K. Salkintzis, Athens (GR)

(73) Assignee: MOTOROLA MOBILITY, INC., Libertyville, IL (US)

(21) Appl. No.: 13/476,551

(22) Filed: May 21, 2012

(51) Int. Cl. H04W 8/00

(52) U.S. Cl. 709/219

(57) ABSTRACT

In a wireless communication device (102), a method for retrieving content comprises receiving (300) a request for retrieval of content from a remote server (118), determining (302) a total number of connections to be used for retrieving the requested content based on a size of the requested content and transfer policies provided to the wireless communication device and dividing (304) the size of the requested content into segments of requested content to be retrieved based on the determined total number of connections. When the determined total number of connections is greater than one, a plurality of connections to the remote server are established (306), the number of established connections corresponding to the determined total number of connections. Each of the segments of the requested content is retrieved (308) over a respective one of the established connections and the retrieved segments are assembled (312) to provide the requested content.

### FIELD OF THE DISCLOSURE

This disclosure relates to a method for retrieving content by a wireless communication device. A wireless communication device is also disclosed and claimed.

### BACKGROUND OF THE DISCLOSURE

Mobile devices are increasingly used to access several types of content, including data files and multimedia content, for example from the Internet. Such data files can be large documents, presentations, spreadsheets, etc, with a size in the order of several of tens of Mbytes. In order to avoid negative user experience, access to these files should ideally be provided to the user in a timely manner. However, given that the vast majority of these files are transferred over the HyperText Transfer Protocol (HTTP)/Transmission Control Protocol (TCP) protocol and given that the TCP protocol (as implemented in mobile devices today) does not make optimum use of communication resources, file access can be very slow especially under network congestion situations. This leads to a negative user experience.

For example, FIG. 17 is a block diagram representation of an example of content 1700 which may be retrieved by a mobile device using HTTP protocol and a single TCP connection. FIG. 18 is a graphical representation showing the rate of retrieval at a mobile device of the content of FIG. 17 over the TCP connection. The content 1700 as shown in FIG. 17 is identified by a Universal Resource Identifier (URI) and includes a small HTTP header 1702 plus the entire content 1704 of the URI. The mobile device establishes a TCP connection to the server on which the content identified by a URI is stored and over this TCP connection it sends an HTTP GET message that requests the entire content identified by the URI. In this example the content length is 444,864 bytes. FIG. 18 shows the TCP throughput (rate of retrieval) over time. At first, the throughput slowly ramps up (this corresponds to the slow-start phase of TCP that is used to avoid congestion) and then the throughput fluctuates up and down based on the packet loss rate of the communication path and the Round Trip Time (RTT) time. The fluctuation is not shown in FIG. 18. At time t0, the entire content has been received by the mobile device so the mobile device closes the TCP connection with the server and the file transfer is completed. As discussed before, one of the problems associated with this file transfer method is that the communication resources are not efficiently utilized by the TCP protocol mostly due to the TCP mechanisms for congestion avoidance. Such mechanisms are described in RFC 5681, “TCP Congestion Control” and RFC 2001, “TCP Slow Start, Congestion Avoidance, Fast Retransmit, and Fast Recovery Algorithms”. Thus, the delay of file transfer (t0 in this example) can be large and can lead to bad user experience.

### BRIEF DESCRIPTION OF THE DRAWINGS

A method for retrieving content by a wireless communication device, and a wireless communication device in accordance with different aspects of the disclosure will now be described, by way of example only, with reference to the accompanying drawings in which:

FIG. 1 is a block diagram of a communication system in accordance with an example embodiment of the present disclosure;

FIG. 2 is a block diagram of a wireless communication device in accordance with an example embodiment of the present disclosure;

FIG. 3 is a flow diagram showing an example method for retrieving content by a wireless communication device in accordance with an embodiment of the disclosure;

FIG. 4 is a block diagram showing an example of content which may be retrieved by the wireless communication device of FIG. 2 using HTTP protocol;

FIGS. 5-8 are graphical representations showing the rate of retrieval over time at the wireless communication device of FIG. 2 of the segments of the example content shown in FIG. 4;

FIGS. 9-11 are graphical representations showing experimental results for the time taken for the wireless communication device of FIG. 2 to retrieve content over several experiments and with different communication resources;

FIGS. 12-14 are graphical representations showing the effect of packet looses in single and multiple TCP connections;

FIG. 15 is a block diagram showing a first example implementation of the content retrieval method in accordance with the disclosure;

FIG. 16 is a block diagram showing a second example implementation of the content retrieval method in accordance with the disclosure;

FIG. 17 is a block diagram showing an example of content which may be retrieved by a mobile device using HTTP protocol; and

FIG. 18 is a graphical representation showing the rate of retrieval over time at a mobile device of the content shown in FIG. 17 using HTTP over a single TCP connection.

### DETAILED DESCRIPTION OF THE DRAWINGS

The present disclosure will be described with reference to a wireless communication device capable of operating with a WiFi access network for example. It will however be appreciated that the present disclosure may apply to other types of networks and wireless communication devices capable of operating with one or any combination of two or more different networks, which may be selected from, for example: GSM; Enhanced Data rates for GSM Evolution (EDGE); General Packet Radio System (GPRS); CDMA, such as IS-95; CDMA2000; WCDMA or Universal Mobile Telecommunications System (UMTS); Fourth Generation Long Term Evolution (LTE); other wide area network communication systems; Private Mobile Radio (PMR); Worldwide Interoperability for Microwave Access (WIMAX); WLAN; other 3G or 4G networks; or the like. By describing the disclosure with respect to a WiFi network, it is not intended to limit the disclosure in any way.

The wireless communication device may be a portable or mobile telephone, a Personal Digital Assistant (PDA), a wireless video or multimedia device, a portable computer, a netbook, a tablet device, an embedded communication processor or similar wireless communication device. In the following description, the wireless communication device will be referred to generally as a client for illustrative purposes and it is not intended to limit the disclosure to any particular type of wireless communication device.

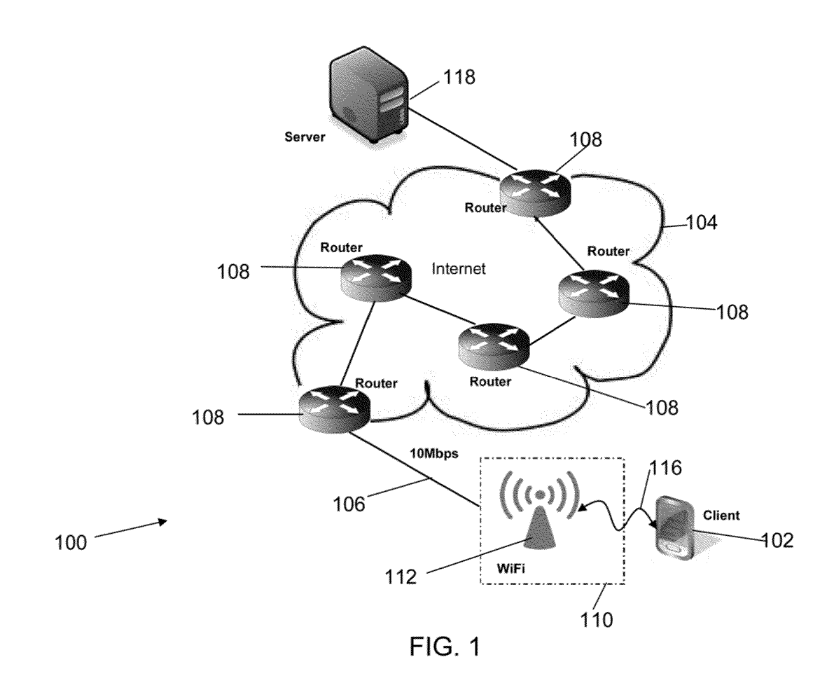

Referring firstly to FIG. 1, a communication system 100 in accordance with an example embodiment of the disclosure comprises at least one client 102 (but typically a plurality of clients), capable of communicating with an access network, such as WiFi network 110.

The coverage area (not shown) of the WiFi network 110 is served by at least one access point (AP) 112. The client 102 can operate or communicate with the WiFi network 110 via radio communication link 116. The WiFi network 110 is communicatively coupled to a remote server 118 in order to provide services to a user of the client 102.

In FIG. 1, the WiFi network 110 is communicably coupled to the remote server 118 via the Internet 104. The WiFi network 110 may however be coupled to the remote server 118 by alternative communication means, such as a leased line, a virtual private network (VPN), a core network other than the Internet or similar means.

The WiFi network 110 is communicably coupled to the Internet 104 by means of a communication link 106. The Internet comprises routers 108. In the example shown in FIG. 1, the communication path between the WiFi network 110 and remote server 118 uses five routers 108. It will be readily apparent that different numbers of routers may be used in the communication path between the client 102 and the remote server 118.

The WiFi network 110 may also be coupled to one or more other networks (not shown), such as a packet data network, a circuit switched (CS) network, an IP Multimedia Subsystem (IMS) network, in order to provide services to or from the client 102.

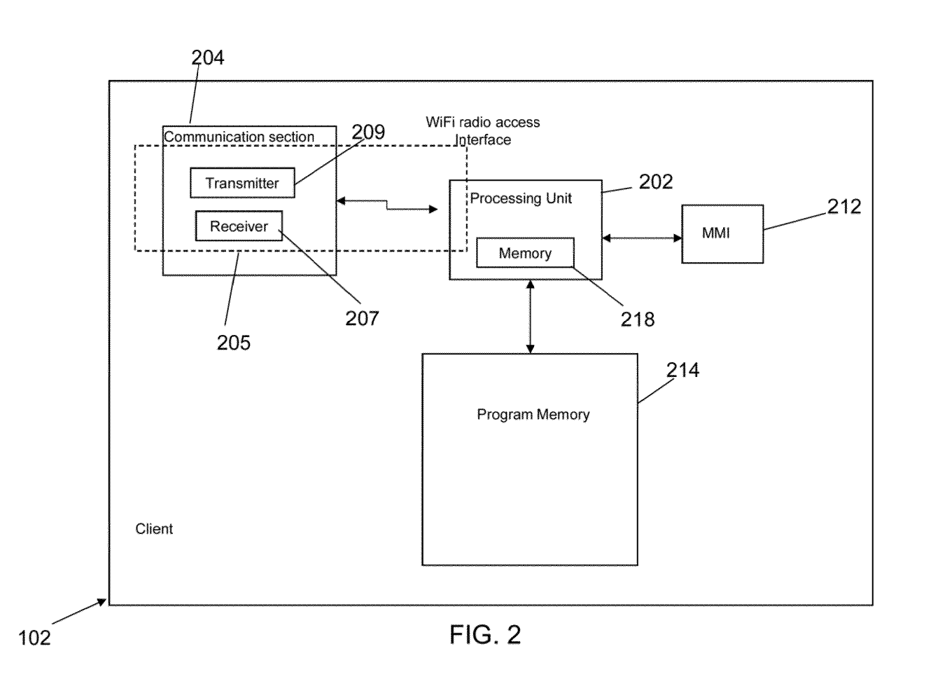

FIG. 2 is a block diagram of a wireless communication device, such as a client 102 shown in FIG. 1, in accordance with an embodiment of the disclosure. As will be apparent to a person of ordinary skill in the art, FIG. 2 shows only the main functional components of an exemplary client 102 that are necessary for an understanding of the invention.

The client 102 comprises a processing unit 202 for carrying out operational processing for the client 102. The client 102 also has a communication section 204 for providing wireless communication via a radio communication link with, for example, the AP 112 of the WiFi network 110. The communication section 204 typically includes at least one antenna (not shown), at least one receiver (207) and at least one transmitter (209), at least one modulation/demodulation section (not shown), and at least one coding/decoding section (not shown), for example, as will be known to a person of ordinary skill in the art and thus will not be described further herein. As is well known, elements of the communication section 204 form part of at least one radio access interface (e.g. WiFi radio access interface 205) of the client 102 and the client 102 may communicate with the remote server 118 via the radio access interface 205 and a radio access technology connection: e.g. a TCP connection via the WiFi radio access interface 205. The WiFi interface 205 includes both hardware, such as the receiver 207 and the transmitter 209, and software that is executed by the processing unit 202. Hence the WiFi interface 205 is shown in FIG. 2 as a dotted box extending across different elements of the client 102. If the client 102 is capable of communicating with at least two access networks, the communication section 204 may include one set of elements for one radio access interface and at least one other set of elements for at least one other radio access interface or the interfaces may share elements. The communication section 204 is coupled to the processing unit 202.

The client 102 also has a Man Machine Interface MMI 212, including elements such as a key pad, microphone, speaker, display screen, for providing an interface between the client and the user of the client 102. The MMI 212 is coupled to the processing unit 202.

The processing unit 202 may be a single processor or may comprise two or more processors carrying out all processing required for the operation of the client 102. The number of processors and the allocation of processing functions to the processing unit is a matter of design choice for a person of ordinary skill in the art. The client 102 also has a program memory 214 in which are stored programs containing processor instructions for operation of the client 102. The programs may contain a number of different program elements or sub-routines containing processor instructions for a variety of different tasks, for example: communicating with the user via the MMI 212; processing signalling messages (e.g. broadcast signals) received from the WiFi network 110; and performing neighbouring coverage area measurements. The program memory 214 may store program elements which, when run on the processing unit 202, control the client 102 to perform the method of retrieving content in accordance with the disclosure.

The client 102 may further include a memory 218 for storing information. The memory 218 is shown in FIG. 2 as part of the processing unit 202 but may instead be separate (e.g. part of program memory 214).

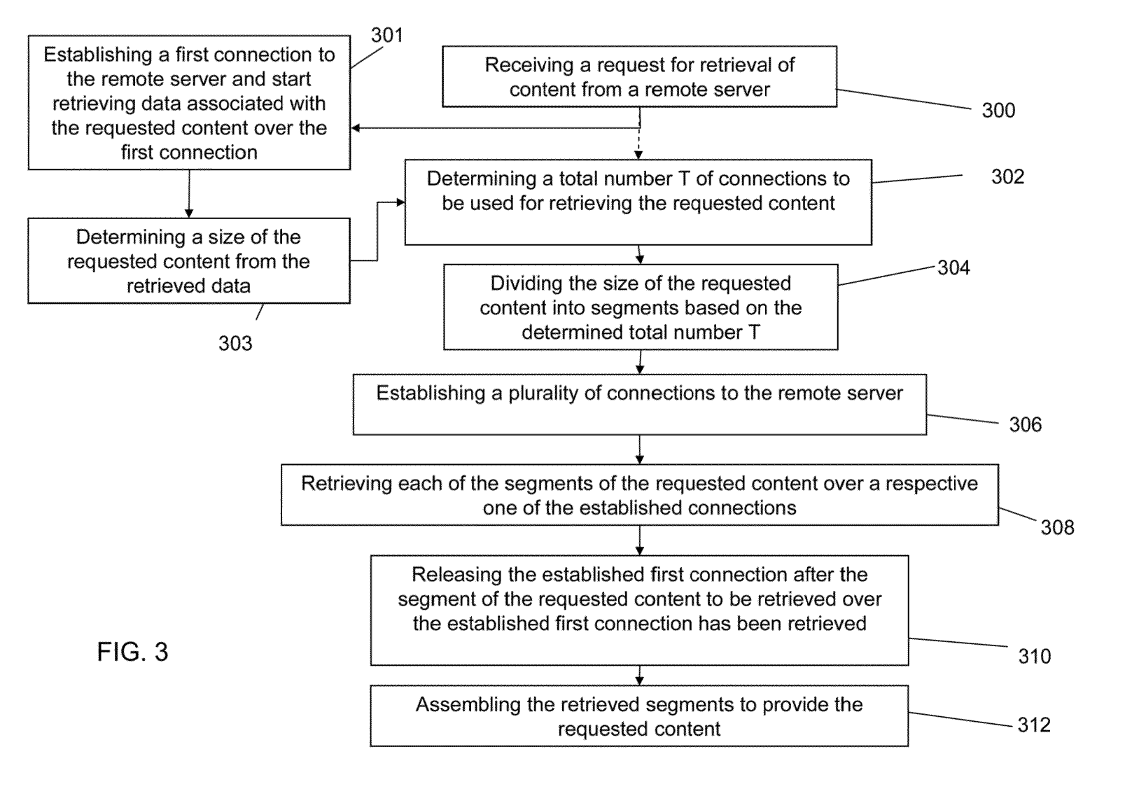

FIG. 3 shows steps of a method for retrieving content by a wireless communication device in accordance with an example embodiment of the disclosure. The method shall be described with reference to the communication system 100 of FIG. 1 and the client 102 of FIG. 2 by way of example. It is not intended to limit the invention to the particular type of network shown and described with reference to FIG. 1.

The transfer or retrieval method used to deliver the requested content in accordance with the disclosure may use a transfer protocol, such as HTTP or File Transfer Protocol (FTP), at the application layer or session layer and may use connections between the client 102 and the remote server 118, such as TCP connections, at the transport layer. Other transfer protocols and connections may instead be used such as Stream Control Transmission Protocol (SCTP) connections, Secure Sockets Layer (SSL) connections, etc. The disclosure herein will be described with reference to retrieving content using HTTP and over TCP connections but it is not intended to limit the disclosure to these particular protocols.

In an embodiment of the disclosure, at step 300, the client 102 receives a request for retrieval of content from the remote server 118. The remote server 118 is communicably coupled to the WiFi network 110. The request for retrieval of content may be received when the client 102 is communicating with WiFi network 110 via an active WiFi radio access interface (not shown). The request for retrieval may be received from a user of the client 102 (e.g. via the MMI 212) or from an application running on the client 102 (e.g. a video application stored in program memory 214). The content may be video, an image, a web page, a file or other type of content available from the remote server 118. For example, a user of the client 102 may be browsing a web site and may identify a video clip that the user wishes to retrieve. The video clip is identified by a Universal Resource Identifier (URI). The request to retrieve content will include the URI for the video clip.

At step 301, in response to receiving the request for retrieval of content, the client 102 (e.g. by means of the processing unit 202 under control of program elements) is configured to establish a first TCP connection to the remote server 118 and start retrieving data associated with the requested content over the established first TCP connection. The client 102 may start the retrieval of data associated with the requested content over the established first TCP connection by sending a request message (e.g. HTTP GET message) over the established first TCP connection to the remote server 118 for the requested content (e.g. the entire requested content).

At step 303, the client (e.g. by means of the processing unit 202 under control of program elements) is configured to determine a size or length of the requested content from the retrieved data. The data associated with the requested content retrieved over the established first connection may include information indicating the size or length of the requested content and may include part of the content itself. For example, the data may include at least the HTTP header for the requested content which includes information indicating the size or length of the requested content (in the HTTP Content-Length header).

At step 302, the client 102 (e.g. by means of the processing unit 202 under the control of program elements) determines a total number T of TCP connections to be used for retrieving the requested content based on the determined size or length of the requested content and transfer policies provided to the client 102. Transfer policies may be stored in the client 102, for example, in memory 218 or program memory 214. The transfer policies may be statically configured, for example, by the client manufacturer in the factory, or may be configured subsequently (e.g. by over-the-air programming or by the user). The transfer policies provide rules to the client 102 which are applied by the client 102 to control content retrieval such that content may be retrieved as optimally and quickly as possible. The transfer policies include at least one of the following: a rule specifying a minimum amount of data to be retrieved over a single connection (e.g. a TCP connection should not transfer less than 100 Kbytes); connectivity status information (e.g. provided by the radio access layer of the client 102) that indicates the effective bandwidth available for retrieving content; and a rule(s) based on at least one property of the content to be retrieved (e.g. size of the content, type of the content, etc.).

The connectivity status information may include Hotspot WAN Metrics as defined in clause 4.4 of “Hotspot 2.0 Specification, Phase 1, Version 0.39”, Wi-Fi Alliance Technical Committee Hotspot 2.0 Task Group, 21 Feb. 2012. The Hotspot WAN Metrics provide information about the link (referred to as the Wireless Access Network (WAN) link) connecting a WAN and the Internet and include: the status of the WAN link, such as link 106 in FIG. 1, which may be up or down; WAN Uplink (UL)/Downlink (DL) speed, WAN load (e.g. loading of the UL and DL WAN connection).

The transfer policies may include rules based on these WAN metrics and/or properties of the retrieved content. For example, a rule may specify “when WAN Load exceeds 75%, retrieve content by using multiple simultaneous TCP connections” or “when the WAN Downlink Speed is less or equal to 10 Mbps and WAN load exceeds 50%, retrieve content by using multiple simultaneous TCP connections and at least 100 Kbytes per TCP connection”. The transfer policies intend to provide rules to the client 102 so as to expedite the content retrieval. For example, when the WAN Load is relatively high (e.g. exceeds 70%), the transfer policies may indicate to the client 102 to split the retrieval of content into a relatively large number of TCP connections, in order to combat the expected large packet loss that the large WAN load can create. The client 102 may also take into account the WAN DL speed and the WAN Load to calculate the effective bandwidth available for retrieving the content and determine the number of TCP connections to use based on the calculated effective bandwidth. The larger the calculated bandwidth, the fewer TCP connections are required to retrieve the content.

In another example, the transfer policies may be based only on a property of the content to be retrieved (e.g. the size of the requested content). For example, the transfer policies may include a rule indicating that “Content with size larger than 1 Mbyte should be transferred with multiple simultaneous TCP connections and every TCP connection should transfer at least 200 Kbytes of content”. In this case, when the client determines that the requested content is 2 Mbytes, it may setup 10 simultaneous TCP connections to retrieve the content (T=10).

Referring back to FIG. 3, at step 304, the client 102 (e.g. by means of the processing unit 202 under the control of program elements) divides the size or length of the requested content into segments of requested content to be retrieved based on the determined total number T of TCP connections. The segments may be of equal size or may be different sizes. For example, for requested content having a certain size in bytes, the client 102 divides the size of the requested content into segments defined by byte ranges: segment 1 corresponds to bytes 1 to x of the requested content, segment 2 corresponds to bytes (x+1) to y of the requested content, segment 3 corresponds to bytes (y+1) to z of the requested content, etc.

When the determined total number T of TCP connections is greater than one, the client 102 (e.g. by means of the processing unit 202) establishes (step 306) a plurality of TCP connections to the remote server 118. The number of established TCP connections corresponds to the determined total number T of TCP connections. In the present example with the first TCP connection already established at step 301, the client 102 is arranged to establish a plurality of TCP connections to the remote server 118 (step 306) by establishing at least one additional TCP connection to the remote server 118 such that the number of additional TCP connections plus the first TCP connection corresponds to the determined total number T of TCP connections. In other words, the plurality of TCP connections established includes the first TCP connection (which is established first) and at least one additional TCP connection.

The plurality of TCP connections are established using the same radio access interface (e.g. the WiFi radio access interface 205) such that they share a single communication path between the client 102 and remote server 118. With reference to FIG. 1, the communication path may include the WiFi communication link 116, the communication link 106 and all links between the routers 108 to the remote server 118. The plurality of TCP connections may be established such that they use the same IP addresses. In other words, the plurality of TCP connections may be established such that they share the same source and destination IP addresses (e.g. they all use the same IP address at the remote server 118 and use the same IP address at the client 102).

At step 308, the client 102 (e.g. by means of the processing unit 202) retrieves each of the segments of the requested content over a respective one of the established TCP connections (e.g. over a respective of the established first and at least one additional connections). The segments of the requested content may be retrieved simultaneously or concurrently over the established TCP connections. The segments of the requested content are retrieved simultaneously in the sense that all the segments of the requested content are received via their respective established TCP connections at the same time or substantially at the same time (that is, not sequentially).

For the established first TCP connection, the client when starting to retrieve data associated with the requested content may start to receive bytes of the requested content and thus, a segment is retrieved over the established first TCP connection by continuing to retrieve bytes of the requested content until the client 102 determines that the size (e.g. byte range) of the requested content retrieved over the established first TCP connection is at least equal to the size (e.g. byte range) of the segment determined to be retrieved over the established first connection in step 304.

For each of the established at least one additional TCP connections, the client 102 may retrieve a respective segment of the requested content by sending a request message (e.g. a HTTP GET message) to the remote server 118 over the established additional TCP connection. The request message includes information indicating the segment of the requested content to be retrieved over the established additional connection: for example, the request message indicates the range of bytes (e.g. bytes 111,216 to 22,431) of the requested content to be retrieved over the established additional TCP connection.

The client 102 (e.g. by means of the processing unit 202) releases the established first TCP connection after the segment of the requested content to be retrieved over the established first TCP connection has been retrieved. For example, the client 102 monitors the size of data retrieved over the established first TCP connection and releases the established first TCP connection after the size of retrieved data is at least equal to or exceeds the size of the segment to be retrieved over the first TCP connection. Each of the other established TCP connections, is normally terminated (either by the remote server 118 or by the client 102) after the segment of the requested content to be retrieved over the established TCP connection (i.e. all the requested range of bytes) have been received.

At step 312, the client 102 may then assemble the retrieved segments to provide the requested content after all the segments have been retrieved by the client 102. For example, the client 102 may assemble the retrieved segments to re-construct the entire content and store the entire content to local storage (e.g. memory 218) or deliver the entire content to the entity that originally requested the content, such as an application.

In a case when the client 102 can determine the size of the requested content without the need to start retrieving data associated with the requested content (e.g. determine the size from a HTTP header), steps 301 and 303 of FIG. 3 can be omitted and the method in accordance with the disclosure can proceed from step 300 to 302 as shown by the dotted line in FIG. 3. For example, in the case where the client 102 receives a request to retrieve a file attached to an email, the size of the file may be indicated in the email and the client 102 does not need to establish a first TCP connection in order to determine the size of the file to be retrieved. The client then determines the total number T of TCP connections to be used based on the size of the requested content and transfer policies and divides the size of the requested content into segments as described above for steps 302 and 304. The client 102 then establishes a plurality of TCP connections corresponding to the determined total number of connections and retrieves each of the segments (e.g. bytes x to y) over a respective one of the established connections. The client 102 may then assemble the retrieved segments to provide the requested content after all the segments have been retrieved, each one on its respective TCP connection. In this case, step 310 may be omitted and each TCP connection may be terminated once the segment to be retrieved over the TCP connection has been received. When the client determines that only one TCP connection is required to retrieve the requested content (e.g. when the size of the requested content is small), the client 102 continues to retrieve the requested content over the established first TCP connection and does not establish any additional TCP connections. In this case, the client 102 may be considered to divide the requested content into ‘one’ segment.

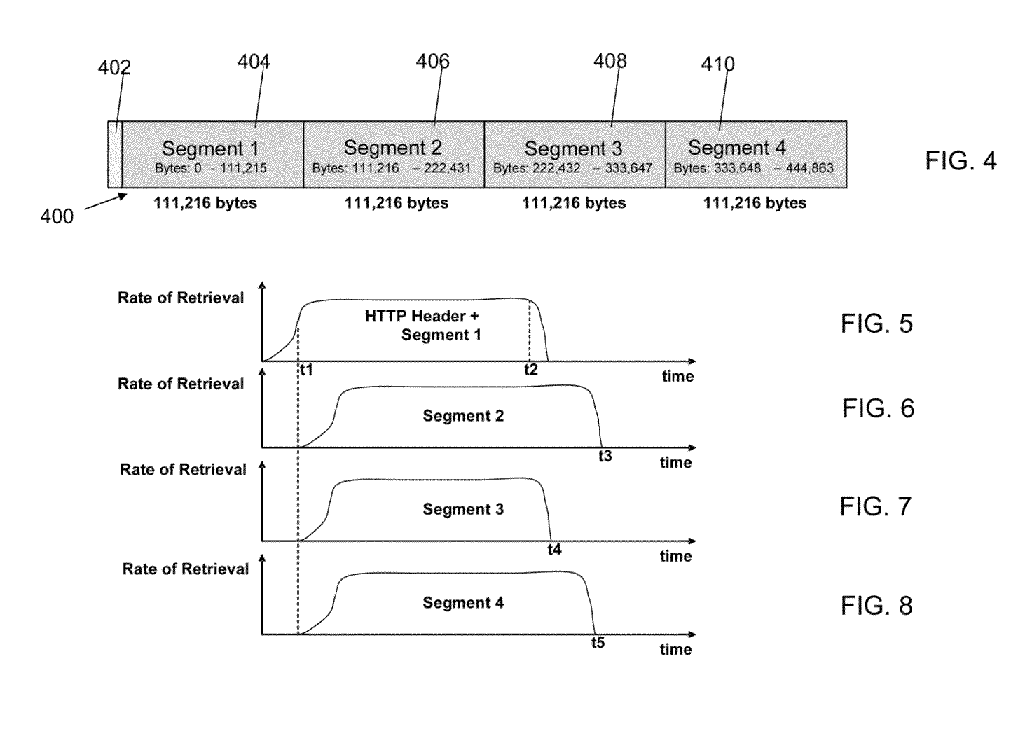

FIG. 4 is a block diagram representation of an example of content 400 which may be retrieved by the client 102 using the HTTP protocol in accordance with an example embodiment of the disclosure. FIGS. 5-8 are graphical representations showing the rate of retrieval at the client 102 of the segments of the example shown in FIG. 4 over the respective established TCP connections.

A HTTP header 402 associated with the content 400 includes information indicating the size of the content (e.g. 444,864 bytes). For the example shown in FIG. 4, once the client 102 has received the HTTP header 402 over the established first TCP connection and determined the size of the content 400 (e.g. 444,864 bytes), the client 102 determines that four TCP connections are to be used to retrieve the content 400 based on the size and transfer policies (at time t1 in FIG. 5). Next, the client 102 divides the size of the content into four segments 404-410 of equal size, with each segment 404-410 having a size or length of 111, 216 bytes. Segment 1 (404) is to be transferred by using the established first TCP connection, while segments 2 (406), 3 (408) and 4 (410) are to be transferred by three additional TCP connections respectively.

After making the decision to split the content to be retrieved into four TCP connections (at time t1 in FIG. 5), the client 102 establishes three additional TCP connections to the remote server 118 (called second, third and forth connections). In the second connection, the client 102 sends an HTTP GET message requesting bytes 111,216-222,431, i.e. segment 2 (406) of the requested content. Similarly, in each of the third and forth connections, the client 102 sends an HTTP GET message requesting bytes 222,432-333,647 and bytes 333,648-444,863 respectively, i.e. segment 3 (408) and segment 4 (410) respectively. FIG. 5 shows the rate of retrieval for segment 1 (404), FIG. 6 shows the rate of retrieval for segment 2 (406), FIG. 7 shows the rate of retrieval for segment 3 (408) and FIG. 8 shows the rate of retrieval for segment 4 (410). After creating the three additional TCP connections, the client 102 configures the existing first TCP connection to stop receiving further data (e.g. to send a TCP packet with the Reset (RST) flag) after receiving all data of segment 1 (bytes 0-111,215). In the example shown in FIG. 5, this occurs at time t2. When all four TCP connections have received the intended size of data (i.e. 111,216 bytes in this example), at times t2, t3, t4 and t5 respectively, then the client 102 has received all four segments of the requested file.

As can be seen in FIGS. 5-8, the segments are received simultaneously or concurrently over the plurality of TCP connections and so the requested content can be received much quicker than with a single TCP connection (as will be explained below). Even though the segments 1-4 are of equal size, in the examples shown in FIGS. 5-8, the duration of retrieval (transfer delay) for the segments is not the same (as can be seen by the different times t1-t2, t1-t3, t1-t4, t1-t5). This is due to the randomness of the communication channel which can impact the download rate of each segment differently in a random fashion.

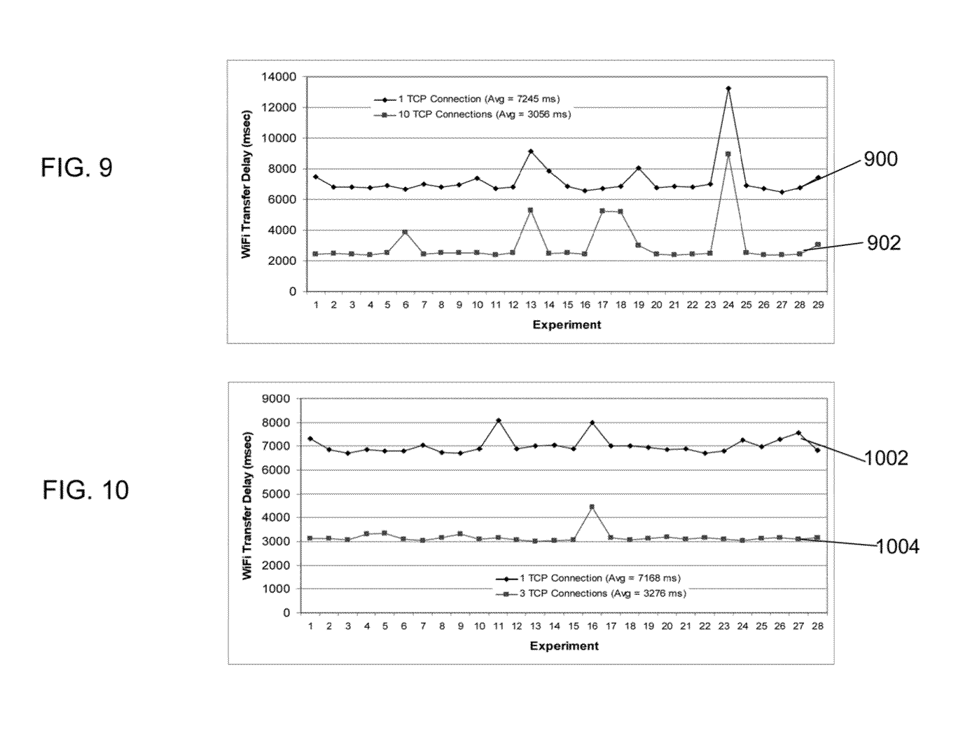

In order to validate the principle that when multiple TCP connections are used to retrieve content the performance of the retrieval is increased compared to using a single TCP connection, experiments were performed using a Motorola Xoom™ tablet device as the client device 102 configured to run a prototype application in a set up as shown in FIG. 1. The results are shown in FIGS. 9-11.

FIGS. 9 and 10 show the results obtained for the WiFi transfer delay (i.e. the time taken for the client 102 to retrieve content from the remote server 118 over a WiFi network 110) from several experiments (numbered along the x axis) conducted over a “long” communication path between the client 102 and the remote server 118. The communication path was characterized by a large number of routers 108 (>25) and a large round-trip time (RTT)>200 ms. The same content was retrieved from the remote server 118 in every experiment and was 1,364,613 bytes in size. Each router 108 along the path could drop packets based on its own congestion avoidance scheme. Due to the long length of the communication path, the packet loss rate was also relatively high (although not precisely measured).

In FIG. 9, every experiment corresponds to two content retrieval or file transfer operations. The first transfer was done with 1 TCP connection (curve 900) and immediately after, a second transfer was repeated with 10 simultaneous TCP connections (curve 902) (i.e. data was retrieved substantially simultaneously over 10 TCP connections). The HTTP protocol was used to retrieve content and thus, each TCP connection corresponds to an HTTP GET operation. When retrieving content with 10 TCP connections, each TCP connection was an HTTP GET requesting 1/10th of the content, i.e. connection 1 was used to get bytes 0-136,461, connection 2 was used to get bytes 136,462-272,921, etc. These connections were running in parallel, each one in its own thread. When all these connections were completed, the content retrieval was considered complete and the transfer delay was measured.

As can be seen from FIG. 9, when the content retrieval is conducted over 10 simultaneous TCP connections, the transfer delay can be reduced by 2.4 times on average. In absolute numbers, the content retrieval with 10 TCP connections takes on average 3056 ms, while the same content retrieval with 1 TCP connection takes on average 7245 ms. This means that with 10 TCP connections (and under the communication conditions described above) the expected transfer delay is 58% smaller than the expected transfer delay with 1 TCP connection. This shows that the same communication resources are far better utilized when multiple TCP connections are used to retrieve the content.

FIG. 10 shows additional multiple transfer delay experiments, each experiment corresponds to a retrieval of content with 1 TCP connection (curve 1002) and with 3 TCP connections (curve 1004) instead of 10 TCP connections shown in FIG. 9. By comparing FIGS. 9 and 10, it can be deduced that (a) the performance gain with 3 TCP connections is still good—transfer delay is 2.2 times smaller on average—and (b) increasing the number of TCP connections from 3 to 10 results only in minor performance gain. In other words, even with a very small number of simultaneous TCP connections, the performance gain is significant when the communication path is long.

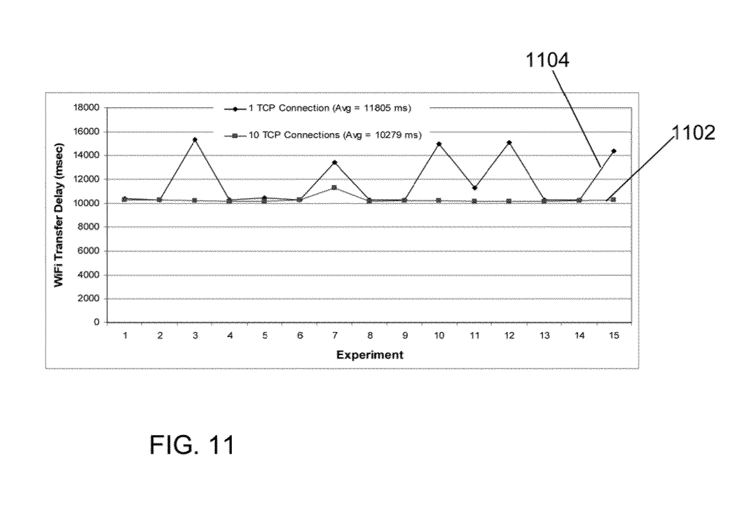

FIG. 11 shows how the transfer delay is impacted by the length of the communication path between the client 102 and the remote server 118. In this figure, the communication path between the client 102 and the remote server 118 is “short” having 10 routers 108 and a round-trip time RTT˜=45 ms. The size of the content retrieved is 10,844,866 bytes. In this case, the transfer delay with 10 TCP connections (curve 1102) is only 1.15 times smaller on average from the transfer delay with 1 TCP connection (curve 1104). By comparing FIG. 11 with FIG. 9, it can be seen that the performance gain of content retrieval with multiple TCP connections is much better when the communication path is long, or (equivalently) when the maximum throughput of a single TCP connection is small due to large RTT and packet loss rate.

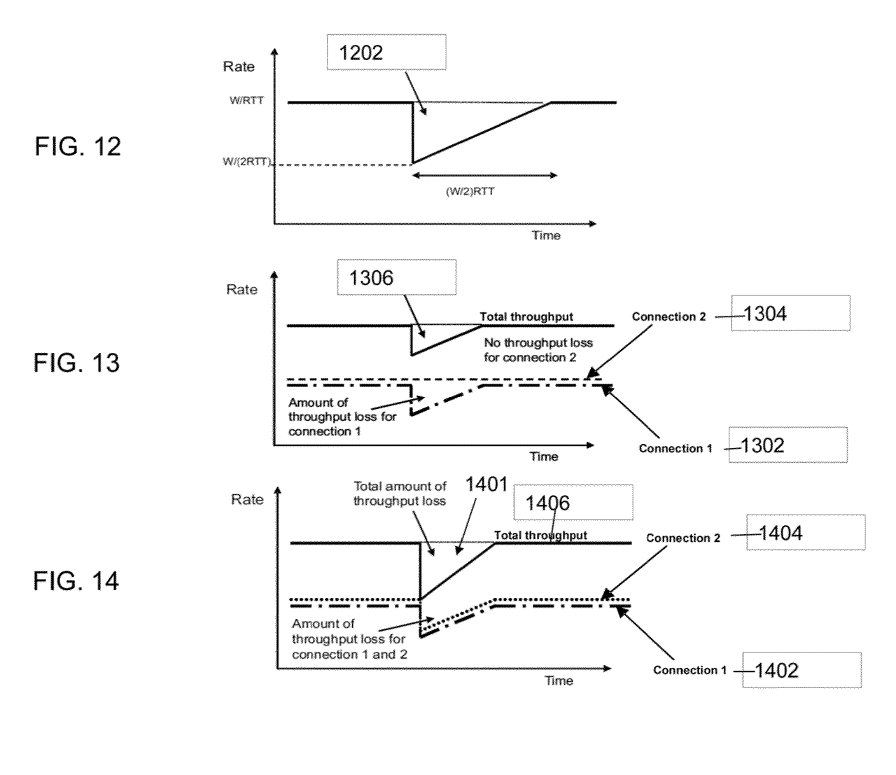

FIGS. 12-14 are taken from a publication entitled ‘Multimedia Streaming Using Multiple TCP Connections’ by Thinh Nguyen and Sen-ching S. Cheung.

FIG. 12 shows how the throughput of a single TCP connection is affected when a packet loss occurs. W denotes the available bandwidth (bits/sec) of the communication path from the client 102 to the remote server 118 and RTT denotes the round-trip time of this path (sec). When a packet loss occurs, the TCP congestion avoidance algorithm (see RFC 5681, “TCP Congestion Control” and RFC 2001, “TCP Slow Start, Congestion Avoidance, Fast Retransmit, and Fast Recovery Algorithms”) will cause the throughput to rapidly drop and then to slowly recover until the maximum value. The recovery rate depends on RTT: the higher the RTT, the longer it takes to fully recover and reach again the maximum throughput (approximately W/RTT). Note in FIG. 12, the triangular area 1202 represents the amount of throughput loss caused by a single packet loss.

FIG. 13 shows the case when there are two TCP connections (see connection 1 (curve 1302) and connection 2 (curve 1304)) over the same communication path with available bandwidth W. In this case, both connections share the same bandwidth so the maximum throughput of each TCP connection is half the throughput of a single TCP connection (i.e. W/2RTT). This figure considers the case when connection 1 (curve 1302) experiences a packet loss whereas the other connection (curve 1304) continues operating without any losses. As shown graphically, the total amount of throughput loss 1306 caused by one packet loss is much smaller than the equivalent throughput loss in FIG. 12 (compare area 1202 with area 1306). Not only the throughput drop is smaller, but the recovery rate is also faster. In other words, the cost of packet losses is smaller because each packet loss causes a smaller drop on the overall TCP throughput and the drop lasts for a shorter duration.

Similarly, FIG. 14 shows again the case when there are two TCP connections (see connection 1 (curve 1402) and connection 2 (curve 1404)) over the same communication path with available bandwidth W. In this case, however, there is one packet loss in each connection. As shown, these packet losses cause the overall throughput (curve 1406) to experience a deep drop (as deep as in FIG. 12) but yet the recovery rate will be faster as compared to FIG. 12 because the individual throughput of each TCP connection does not drop as much as in FIG. 12. So, even in the rare case when both TCP connections experience a packet loss at the same time, the amount of throughput loss as compared to a single TCP connection is smaller (compare area 1202 in FIG. 12 with area 1306 in FIG. 13 and area 1401 in FIG. 14).

In general, FIGS. 12-14 illustrate why the cost of packet losses is smaller when there are multiple TCP connections operating in parallel, or, equivalently, why multiple TCP connections utilize the available communication resource more efficiently. Note that since most Internet routers today apply random early detection (RED) (for example as described in “Recommendations on Queue Management and Congestion Avoidance in the Internet”, RFC 2309, April 1998) as an active queue management scheme to avoid congestion development, the routers along the communication path are expected to randomly drop packets from the multiple TCP connections. Therefore, it is expected that the packet losses experienced by the different TCP connections are statistically independent. This is confirmed by our experimental results.

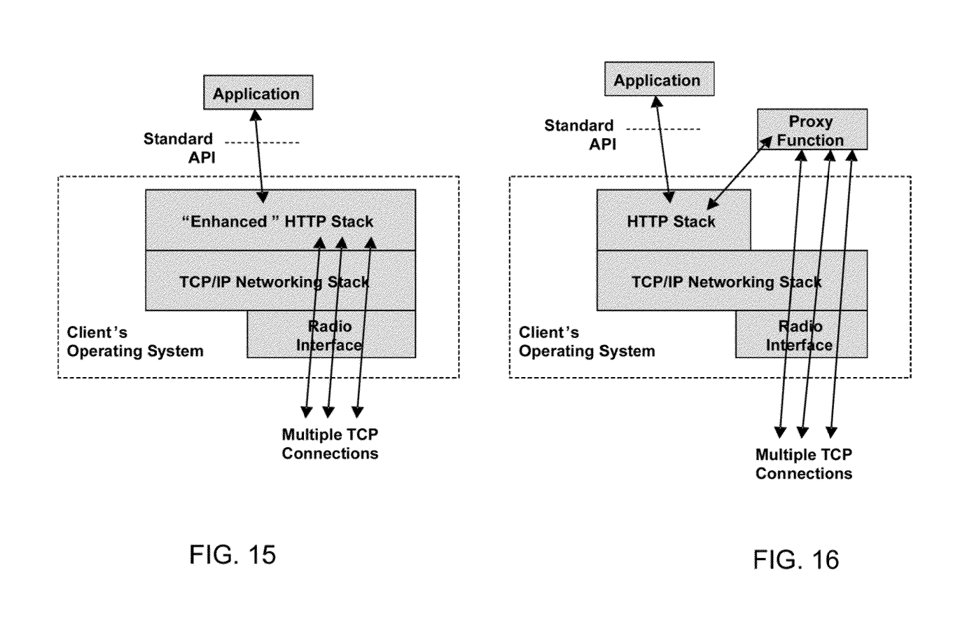

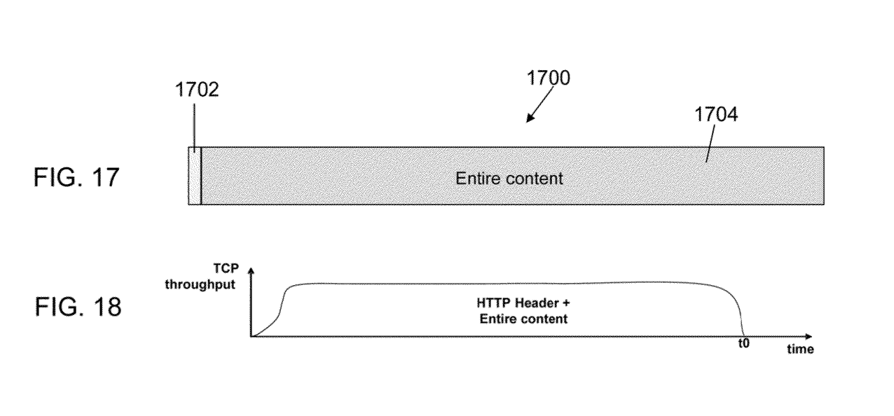

The content retrieval method in accordance with the disclosure may be implemented by the client 102 in an ‘enhanced’ HTTP stack, which is part of the client's operating system (as shown for example in FIG. 15), or in a separate proxy function outside the client's operating system (as shown for example in FIG. 16). In FIG. 15, the HTTP stack of the operating system is enhanced to operate according to the retrieval method described above, i.e. check the size of a requested content and establish multiple TCP connections to retrieve the content based on its size and on transfer policies. On the other hand, in FIG. 16, the HTTP stack in the client's operating system is not enhanced or modified in any way. It is configured to route HTTP requests to a separate proxy function that exists in the client 102 e.g. as a standalone application. The HTTP stack can be configured to route HTTP requests to a proxy function either by changing the HTTP proxy settings or by applying routing policies that redirect all HTTP traffic to the internal address and port number (e.g. 127.0.0.1/8081) of the separate proxy function. It is then up to the proxy function to serve HTTP requests created by applications and to determine to use one or multiple TCP connections to retrieve the URI of an HTTP request in accordance with the disclosure. An advantage of the implementation of FIG. 16 is that no changes are required to the client's operating system and the separate proxy function can be implemented as a new service component in the application layer (i.e. as a standalone application) which makes implementation considerably easier and less expensive.

A known mechanism that can be used for enhanced file transfer is multipath TCP (MPTCP). Details of MPTCP are provided, for example, in RFC 6182: “Architectural Guidelines for Multipath TCP Development”, March 2011, and RFC 6356: “Coupled Congestion Control for Multipath Transport Protocols”, October 2011. With MPTCP, the client and the server can establish multiple, parallel TCP connections which are simultaneously used to retrieve the requested URI. However MPTCP is different to the method in accordance with the present disclosure in at least the following ways:

With MPTCP, the client establishes a first TCP connection to the server and sends a single HTTP GET request. Subsequently, if the client and/or the server have multiple IP addresses available (typically, have multiple interfaces active for IP communications), they negotiate and create additional TCP connections, each one towards a unique pair of IP addresses. Therefore, for MPTCP to work the client and/or the server needs to have multiple IP addresses. With an example arrangement in accordance with the disclosure as described above, the TCP connections can be established sharing IP addresses and a single communication path (e.g. sharing the same pair of client and server IP addresses).

MPTCP applies entirely in the TCP/transport layer and does not affect the HTTP layer. Indeed, with MPTCP the client sends only a single HTTP GET request to the server. With an example arrangement in accordance with the disclosure as described above, the client sends multiple HTTP GET requests to the server, each one for a different byte range.

MPTCP requires tight integration with the client's operating system and thus requires a modified operating system in both the client and server with MPTCP support. However, the embodiments of the methods in accordance with this disclosure does not mandate changes to the operating system in the client (see the implementation shown in FIG. 16) and does not require any modification in the server (a normal HTTP 1.1 stack is sufficient).

MPTCP is based on and uses several new Option fields in the TCP header. Several middleware devices such as firewalls and Network Address Translators (NATs) can thus drop MPTCP packets with the unknown Option fields. This leads to reverting to standard single-path TCP operation. This problem does not exist with the embodiments of the method described in this disclosure.

In summary, by using multiple TCP connections to retrieve content simultaneously, the embodiments of the method in accordance with the disclosure provide improved performance over content retrieval with a single TCP connection. The embodiments of the method can therefore significantly reduce delay in retrieving content by the client and can thus improve user experience. For example, when the overall transfer delay with multiple TCP connections (t3 in FIGS. 5-8) is around 3000 msec, the transfer delay with a single TCP connection (t0 in FIG. 18) can be expected to be around 7000 msec. This is because packet losses are less costly when they are spread across multiple TCP connections. A single packet loss gives rise to an amount of throughput loss that is much smaller to the equivalent throughput loss in a single TCP connection (see FIGS. 12-14). Moreover, even when all TCP connections share the same communication path, the packet losses across these TCP connections may be highly uncorrelated (statistically independent) due to the random early detection (RED) queue management applied by Internet routers. Thus, if a single TCP connection experiences a packet loss and drops its throughput, then, with a high probability, the other TCP connections of the multiple TCP connections will not experience packet losses at this time and will sustain operation at a high transfer rate. Thus, the arrangement in accordance with the disclosure can provide improved resource utilization with multiple TCP connections.

The performance gain obtained by multiple TCP connections increases when the communication path becomes longer, that is, when the round-trip time (RTT) and the packet loss rate increases. The performance gain obtained by increasing the number of TCP connections (e.g. going from 2 connections to 10 connections) is marginal in most cases. However, with more TCP connections used, better performance is expected as the transfer becomes more robust to packet losses. So when determining the number of TCP connections to use, the client 102 (e.g. via the transfer policies) should take into consideration that it is always better to use as many TCP connections as is possible. The upper limit to the number of TCP connections to be used is restricted by the implementation cost and the size of the content to be retrieved. Obviously, establishing 100s of TCP connections and getting 10 bytes in every TCP connection will not improve the performance. These considerations, such as the upper limit for the number of TCP connections may be set out in transfer policies provided to the client 102 which can then be used by the client 102 for selecting the number of TCP connections.

The embodiments of the method in accordance with the disclosure are implemented on the client and thus do not require any upgrade on the server or on the network side (nor middleware devices).

The embodiments of the method in accordance with the disclosure require more processing resources for establishing the multiple TCP connections compared to using a single TCP connection. However, given that most smart phones today support ample processing resources and efficient multi-thread programming, the cost of implementing content transfer with multiple TCP connections is considered negligible.

In the foregoing specification, the disclosure has been described with reference to specific examples of embodiments of the disclosure. It will, however, be evident that various modifications and changes may be made therein without departing from the broader scope of the disclosure.

Some of the above embodiments, as applicable, may be implemented using a variety of different processing systems. For example, the Figures and the discussion thereof describe an exemplary architecture which is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between program and system/device elements are merely illustrative and that alternative embodiments may merge elements or impose an alternate decomposition of functionality upon various elements.

1. A method for retrieving content by a wireless communication device, the method in the wireless communication device comprising:
receiving a request for retrieval of content from a remote server;
establishing a first connection to the remote server and start retrieving data associated with the requested content over the established first connection;
determining a size of the requested content from the retrieved data associated with the requested content;
determining a total number of connections to be used for retrieving the requested content based on the determined size of the requested content and transfer policies provided to the wireless communication device;
dividing the determined size of the requested content into segments of requested content to be retrieved based on the determined total number of connections;
when the determined total number of connections is greater than one, establishing at least one additional connection to the remote server such that the number of additional connections established plus the first connection corresponds to the determined total number of connections;
retrieving each of the segments of the requested content simultaneously over a respective one of the established first and at least one additional connections;
releasing the established first connection after the segment of the requested content to be retrieved over the established first connection has been retrieved.

2. The method of claim 1, further comprising assembling the retrieved segments to provide the requested content after all the segments have been retrieved.

3. The method of claim 1, wherein the transfer policies include at least one of the following: a rule specifying a minimum amount of data to be retrieved over a single connection; connectivity status information that indicates the effective bandwidth available for retrieving content; and a rule based on at least one property of the content to be retrieved.

4. The method of claim 1, wherein the established first connection is established using a radio access interface and the established at least one additional connection is established using the same radio access interface.

5. The method of claim 1, wherein the established first connection and the established at least one additional connection use the same source and destination IP addresses.

6. The method of claim 1, wherein start retrieving includes sending a request message over the established first connection to the remote server for the entire requested content.

7. The method of claim 1, wherein retrieving each segment of the requested content over a respective one of the established at least one additional connection includes sending a request message to the remote server over the established additional connection, the request message including information indicating the segment of the requested content to be retrieved over the established additional connection.

8. The method of claim 1, further comprising monitoring a size of data retrieved over the established first connection and releasing includes releasing the established first connection after the size of retrieved data is at least equal to or exceeds a size of the segment to be retrieved over the first connection.

9. The method of claim 1, wherein each of the connections is a TCP connection and requested content is retrieved using an HTTP protocol.

10. A method for retrieving content by a wireless communication device, the method in the wireless communication device comprising:
receiving a request for retrieval of content from a remote server;
determining a total number of connections to be used for retrieving the requested content based on a size of the requested content and transfer policies provided to the wireless communication device and dividing the size of the requested content into segments of requested content to be retrieved based on the determined total number of connections;
when the determined total number of connections is greater than one, establishing a plurality of connections to the remote server, the number of established connections corresponding to the determined total number of connections and wherein the established plurality of connections are established using at least one of the same radio access interface and the same source and destination IP addresses;
retrieving each of the segments of the requested content over a respective one of the established connections; and
assembling the retrieved segments to provide the requested content after all the segments have been retrieved.

11. A wireless communication device including:
a transmitter;
a receiver;
a processing unit communicably coupled to the transmitter and receiver, the processing unit being configured to:
receive a request for retrieval of content from a remote server;
establish a first connection to the remote server and start retrieving data associated with the requested content over the established first connection;
determine a size of the requested content from the retrieved data associated with the requested content;
determine a total number of connections to be used for retrieving the requested content based on the determined size of the requested content and transfer policies provided to the wireless communication device;
divide the determined size of the requested content into segments of requested content to be retrieved based on the determined total number of connections;
when the determined total number of connections is greater than one, establish at least one additional connection to the remote server such that the number of additional connections established plus the first connection corresponds to the determined total number of connections;
retrieve each of the segments of the requested content simultaneously over a respective one of the established first and at least one additional connections;
release the established first connection after the segment of the requested content to be retrieved over the established first connection has been retrieved.

12. The wireless communication device of claim 11, wherein the processing unit is further configured to assemble the retrieved segments to provide the requested content after all the segments have been retrieved.

13. The wireless communication device of claim 11, wherein the transfer policies include at least one of the following: a rule specifying a minimum amount of data to be retrieved over a single connection; connectivity status information that indicates the effective bandwidth available for retrieving content; and a rule based on at least one property of the content to be retrieved.

14. The wireless communication device of claim 11, wherein the processing unit is configured to establish the first connection and the at least one additional connection using the same radio access interface.

15. The wireless communication device of claim 11, wherein the established first connection and the established at least one additional connection use the same source and destination IP addresses.

16. The wireless communication device of claim 11, wherein the processing unit is configured to start retrieving data by sending a request message over the established first connection to the remote server for the requested content.

17. The wireless communication device of claim 11, wherein the processing unit is configured to retrieve each segment of the requested content over a respective one of the established at least one additional connection by sending a request message to the remote server over the established additional connection, the request message including information indicating the segment of the requested content to be retrieved over the established additional connection.

18. The wireless communication device of claim 11, wherein the processing unit is further configured to monitor a size of data retrieved over the established first connection and to release the established first connection after the size of retrieved data is at least equal to or exceeds a size of the segment to be retrieved over the first connection.

19. The wireless communication device of claim 11, wherein each of the connections is a TCP connection and requested content is retrieved using an HTTP protocol.

20. A wireless communication device including:
a transmitter;
a receiver;
a processing unit communicably coupled to the transmitter and receiver, the processing unit being configured to:
receive a request for retrieval of content from a remote server;
determine a total number of connections to be used for retrieving the requested content based on a size of the requested content and transfer policies provided to the wireless communication device and dividing the size of the requested content into segments of requested content to be retrieved based on the determined total number of connections;
when the determined total number of connections is greater than one, establish a plurality of connections to the remote server, the number of established connections corresponding to the determined total number of connections and wherein the established plurality of connections are established using at least one of the same source and destination IP addresses and the same radio access interface;
retrieve each of the segments of the requested content over a respective one of the established connections; and
assemble the retrieved segments to provide the requested content after all the segments have been retrieved.
